(19) United States
(12) Patent Application Publication
(10) Pub. No.: US 2013/0093379 A1
(43) Pub. Date: Apr. 18, 2013

(54) ELECTRONIC DEVICE WITH GENERATOR UNIT

(71) Applicant: YU-SHENG LIN, Tu-Cheng (TW)

(72) Inventor: YU-SHENG LIN, Tu-Cheng (TW)

(73) Assignee: HON HAI PRECISION INDUSTRY CO., LTD., Tu-Cheng (TW)

(21) Appl. No.: 13/300,621

(22) Filed: Nov. 20, 2011

(30) Foreign Application Priority Data
Oct. 18, 2011 (TW) 100219431

(51) Int. Cl. H02K 47/14; H02J 7/35

(52) U.S. Cl. 320/101; 310/113

(57) ABSTRACT

An electronic device includes a generator unit and a battery. The generator unit includes a fan assembly and a first winding, and the fan assembly includes a fan which has a plurality of fan blades made of magnetic material. The battery is electrically connected to the first winding. Rotation of the fan causes the first winding to cut magnetic lines of force generated by the fan blades, such that induction current is generated in the first winding due to electromagnetic induction and charges the battery.

### BACKGROUND

1. Technical Field

The present disclosure relates to electronic devices, and particularly to an electronic device with a generator unit.

2. Description of Related Art

Many electronic devices, such as personal computers, have fans for dissipating heat. These fans may require much electrical energy. If the electrical energy used by these fans can be recycled (e.g., reused by the fans or other components of the electronic devices), it can be advantageous in saving power resources.

Therefore, there is room for improvement within the art.

### BRIEF DESCRIPTION OF THE DRAWINGS

Many aspects of the present disclosure can be better understood with reference to the following drawing. The components in the various drawings are not necessarily drawn to scale, the emphasis instead being placed upon clearly illustrating the principles of the present disclosure. Moreover, in the drawings, like reference numerals designate corresponding parts throughout the figure.

FIG. 1 is a block diagram of an electronic device, according to an exemplary embodiment.

FIG. 2 is a schematic view of a generator unit of the electronic device shown in FIG. 1.

### DETAILED DESCRIPTION

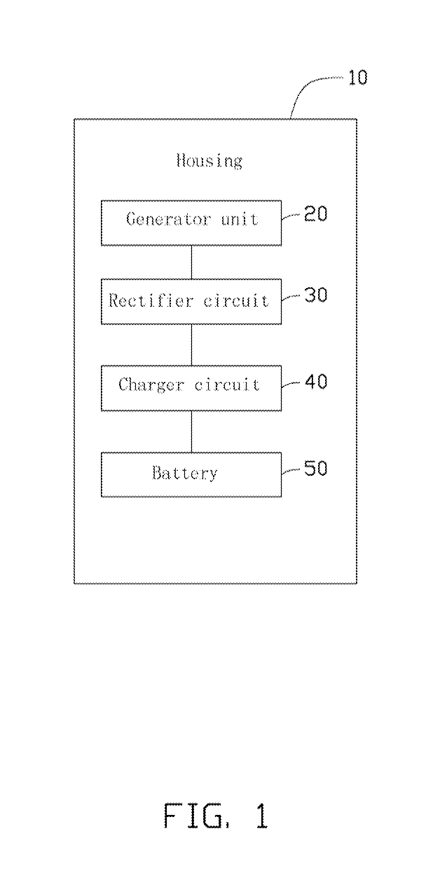

FIG. 1 is a block diagram of an electronic device 100, according to an exemplary embodiment. The electronic device 100 can be a personal computer (PC), and includes a housing 10 and common components of PCs (not shown) installed inside/on the housing 10. The electronic device 100 further includes a generator unit 20, a rectifier circuit 20, a charger circuit 30, and a battery 50, which are all received in the housing 10 and electrically connected in series.

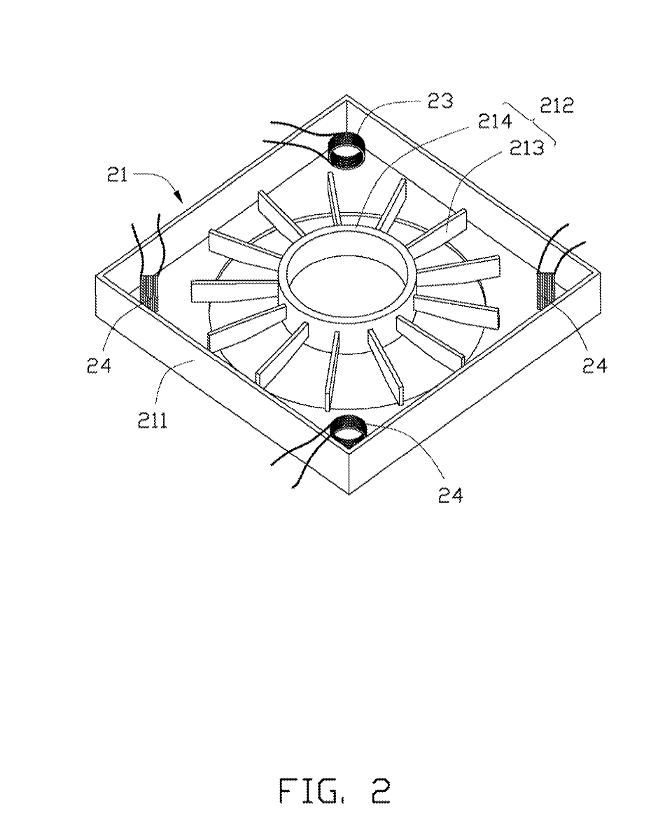

Also referring to FIG. 2, the generator unit 20 includes a fan assembly 21 and a first winding 23. The fan assembly 21 includes a substantially rectangular frame 211 and a fan 212 received in the frame 211. The fan 212 includes a plurality of substantially bar-shaped fan blades 213 and a cylindrical main body 214. The fan blades 213 are made of magnetic material, and are radially and equidistantly connected to an outer surface of the main body 214. Thus, each of the fan blades 213 has a magnetic pole positioned outwards from the fan blade 213, and magnetic lines of force generated by each of the fan blades 213 extend outwards from the fan blade 213. The main body 214 can be driven to rotate by a typical power device (not shown), such as an electric motor, and thus drive the fan blades 213 to rotate and generate wind. In this way, the fan 212 can be used to dissipate heat generated in the electronic device 200.

The first winding 23 is electrically connected to the rectifier circuit 30 and mounted in the frame 211. When the fan 212 rotates, magnetic lines of force generated by the fan blades 213 are cut by the first winding 23, and induction current is generated in the first winding 23. For generating more induction current, the generator unit 20 can further include a plurality of second windings 24, which are all similar to the first winding 23. The first winding 23 and the second windings 24 are all electrically connected to the rectifier circuit 30 and equidistantly positioned in the frame 21. For example, in this embodiment, the generator unit 20 includes three second windings 24, and the first winding 23 and the second windings 24 are respectively positioned at four corners of the frame 211. When the fan 212 rotates, magnetic lines of force generated by the fan blades 213 are respectively cut by the first winding 23 and the second windings 24.

When the electronic device 200 is used, the main body 214 is driven to rotate by a typical power device (not shown), such as an electric motor, of the electronic device 200. The main body 214 further drives the fan blades 213 to rotate and generate wind, and the fan 212 is used to dissipate heat generated in the electronic device 200. At the same time, magnetic lines of force generated by the fan blades 213 are respectively cut by the first winding 23 and the second windings 24, and thus induction current is generated in the first winding 23 and the second windings 24 due to electromagnetic induction.

According to characteristics of electromagnetic induction, the induction current originally generated in the first winding 23 and the second windings 24 is alternating current (AC). The AC is then transmitted to the rectifier circuit 30, and the rectifier circuit 30 converts the AC to direct current (DC). The DC is transmitted to the charger circuit 40 and charges the battery 50 through the charger circuit 40. The charger circuit 40 can adjust values of charging current and voltages for the battery 50. Upon storing enough electrical energy that enables the battery 50 to be used, the battery 50 can supply electrical power to the electronic device 200 or other electronic devices.

In above process, electrical energy for driving the fan assembly 21 to rotate (i.e., to generate wind for dissipating heat) is transformed into kinetic energy of the fan 212. The processes of generating the induction current in the first winding 23 and the second windings 24 and using the induction current to charge the battery 50 substantially transform the kinetic energy of the fan 212 into electrical energy and store the electrical energy in the battery 50. In this way, the electrical energy for driving the fan 212 is recycled (e.g., reused by the fan 212 or other components of the electronic devices), which is advantageous to save power sources.

Furthermore, the electronic device 200 can further include a solar panel (not shown) attached outside the housing 10 and electrically connected to the rectifier circuit 30. The solar panel can transform outside light into electric energy and charges the battery 50 via the rectifier circuit 30 and the charger circuit 40 with the electrical energy. In this way, the battery 50 can have more electrical energy sources and store enough electrical energy that enables the battery 50 to be used as soon as possible.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An electronic device, comprising:
a generator unit, the generator unit including a fan assembly and a first winding, the fan assembly including a fan having a plurality of fan blades made of magnetic material; and
a battery electrically connected to the winding;
wherein rotation of the fan causes the first winding to cut magnetic lines of force generated by the fan blades, such that induction current is generated in the first winding due to electromagnetic induction and charges the battery.

2. The electronic device as claimed in claim 1, further comprising a rectifier circuit electrically connected between the first winding and the battery.

3. The electronic device as claimed in claim 2, further comprising a charger circuit electrically connected between the rectifier circuit and the battery.

4. The electronic device as claimed in claim 1, wherein the fan further includes a cylindrical main body; the fan blades are radially and equidistantly connected to an outer surface of the main body, and rotation of main body drives the fan blades to rotate and generate wind.

5. The electronic device as claimed in claim 1, wherein each of the fan blades has a magnetic pole positioned outwards from the fan blades.

6. The electronic device as claimed in claim 1, further includes a plurality of second windings electrically connected to the battery; rotation of the fan causes the second windings to respectively cut the magnetic lines of force generated by the fan blades, such that induction current is generated in the second windings due to electromagnetic induction and charges the battery.

7. The electronic device as claimed in claim 1, further comprising a solar panel electrically connected to the battery, the solar panel transforms outside light into electrical energy for charging the battery.

8. The electronic device as claimed in claim 1, wherein power stored in the battery is reused by the fan.
